(19) United States
(12) Patent Application Publication
(10) Pub. No.: US 2005/0036023 A1
(43) Pub. Date: Feb. 17, 2005

(54) Printer architecture with upper paper trays

(75) Inventors: Daniel W. Costanza, Webster, NY (US); Michael F. Leo, Penfield, NY (US); Barry P. Mandel, Fairport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/639,388

(22) Filed: Aug. 12, 2003

(51) Int. Cl. B41J 2/01

(52) U.S. Cl. 347/104

(57) ABSTRACT

Convenient placement of media supply trays in a printing apparatus is provided by placing the media supply trays in the printer enclosure at an elevation above the elevation of the print engine. In particular, the imaging station of the print engine is placed at a lower elevation within the printer enclosure than are the media feed heads for each media supply tray. In addition, a substrate heater is positioned along the media path between the media feed heads and the imaging station when the print engine is a phase change ink jet printhead.

### BACKGROUND

This invention relates to printing apparatus, and particularly to the arrangement of major subsystems within a printing apparatus.

Printing apparatus apply images to media such as paper, vinyl, and plastic transparencies. Printers employ print engines that use different types of technology to transfer images onto media substrates. Ink jet printers include both direct marking ink jet printers that directly apply an ink image to the media substrate, and transfer printers that apply the ink image to a imaging member, such as an imaging drum, and subsequently transfers the image from the imaging drum to the media substrate. Electrostatographic or xerographic printers develop an electrostatic image on an imaging element, such as a photoreceptor belt or photoreceptor drum, and then transfers the developed image to the media substrate. The present description of a specific exemplary implementation focuses on office-type printers, such as are typically found in conventional offices. Such printers typically print upon cut sheet media, and may produce up to approximately 100 imaged substrates per minute. Although the principles described can be applied to other types of printers, the exemplary embodiments described here relate particularly to office printers that produce at least approximately 20 imaged substrates per minute.

Media substrates, such as sheets of paper, upon which images are to be placed are typically held in media trays, from which the printer draws each individual sheet of material for imaging by the print engine. Such media trays typically hold at least 100 sheets of standard (16-20 pound) paper, and most typically hold at least 500 sheets (one ream) of paper. Some high capacity trays may hold 1,000-3,000 sheets. Such media trays are conventionally located at or near the lower portions of a printing apparatus enclosure. In particular, for larger, floor mounted (as opposed to desktop) printers, such media trays are typically near floor level.

### SUMMARY

A printing apparatus in accordance with an aspect of the present invention includes a print engine that includes an imaging element, an ink jet printhead for applying an ink image to the imaging element, and an image transfer stage for transferring the ink image from the imaging element to a media substrate. The printer additionally includes at least one media tray for holding a plurality of substrates, a feedhead for removing one of the media substrates from the media tray, and a substrate heater. A media transport transports the media substrate from the feedhead, past the substrate heater, and to the image transfer station. The image transfer station is at a lower elevation than the feedhead within the enclosure for the printing apparatus.

In accordance with another aspect of the present invention, the printing apparatus includes a print engine having an imaging station for applying an image to a media substrate. The printing apparatus additionally includes a first media tray and a first feedhead for selectively removing one media substrate from the first media tray. The printing apparatus additionally includes a second media tray and a second feedhead for selectively removing a media substrate from the second media tray. The printing apparatus additionally includes a media transport for moving the media substrate from the first and second feedheads to the imaging station. The imaging station is at a lower elevation within the printing apparatus enclosure than is both the first and second feedheads.

In accordance with yet another aspect of the invention, a printing apparatus includes a print engine having an imaging station for applying an image to a media substrate, and a plurality of media trays, each for holding a plurality of media substrates. The printing apparatus further includes a plurality of feedheads, each for removing one of the media substrates from an associated one of the media trays, and a media path between the feedheads and the imaging station. The imaging station is at a lower elevation than all of the feedheads.

### BRIEF DESCRIPTION OF THE FIGURES

FIG. 1 is a schematic representation of a printing apparatus incorporating an aspect of the present invention.

FIG. 2 is a schematic representation of another implementation of a printing apparatus in accordance with the present invention.

### DETAILED DESCRIPTION

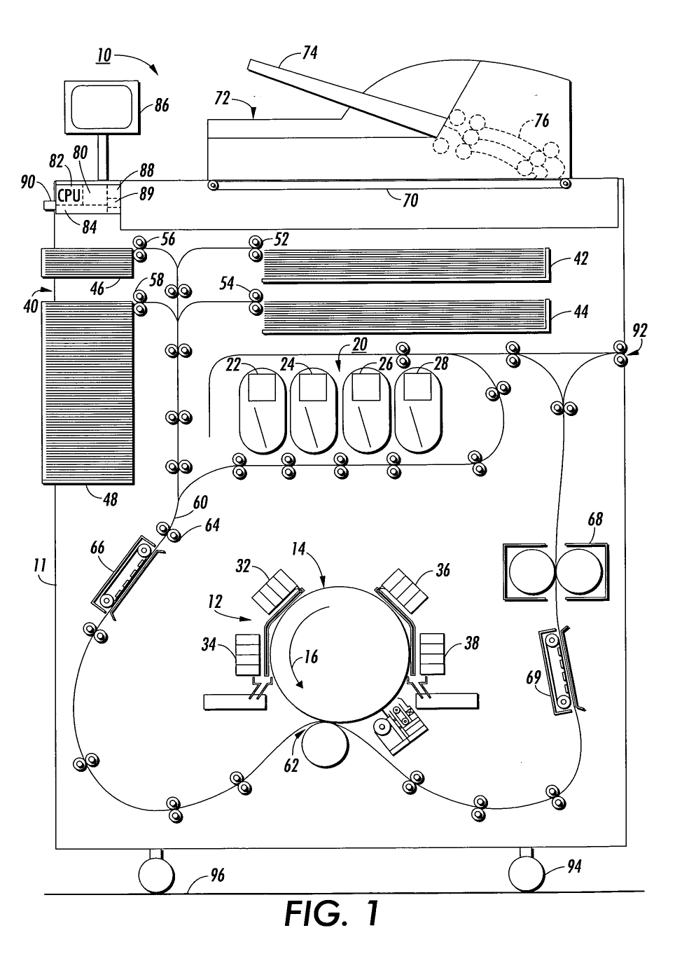

FIG. 1 schematically illustrates an exemplary phase change ink jet printer implementing an aspect of the present invention. The exemplary phase change ink printing apparatus 10 includes a frame or enclosure 11 to which are mounted directly or indirectly the operating subsystems and components thereof. The printer includes an ink jet print engine 12. The exemplary ink jet print engine 12 is a transfer-type ink jet print engine that includes an imaging element 14. The exemplary imaging element 14 is a cylindrical drum that rotates in a rotational direction 16. One or more ink jet printheads 32, 34, 36, 38 apply ink images to the surface of the imaging drum 14 as the drum rotates in the rotational direction 16.

An ink delivery system 20 delivers ink to the printheads 32, 34, 36, 38 so that the printheads can jet the ink onto the surface of the imaging element 14. The ink delivery system 20 includes at least one source 22 of phase change ink of one color in solid form. A multicolor or full color printing apparatus may include several ink sources 22, 24, 26, 28 in the ink delivery system. Each ink source may include a unique color, such as cyan, (c), yellow (y), magenta (m), and black (k). The phase change ink delivery system also includes melting and control apparatus (not shown) for melting (changing the phase of) the solid form of the phase change ink into a liquid form, and then supplying the liquid form to the printheads 32, 34, 36, 38. Each color ink may be supplied to a separate printhead, or all printheads may process all colors. In addition, although four printheads are shown, the print engine may include as few as one printhead, or a multitude of printheads.

The printing apparatus also includes a media substrate supply and handling system 40 that includes at least one media supply tray 42, 44, 46, 48. Each media supply tray holds a predetermined plurality of cut sheet media substrates. The different media trays may be configured to hold cut sheets of different sizes. In addition, at least one of the media trays 48 may be configured to hold a substantially greater number of sheets of a particular medium. Such a high capacity tray is typically used for the media size and type that is most commonly used in the printing apparatus. In certain implementations, one or more of the media supply trays (particularly the high capacity tray 48) may be attached external to the enclosure 11. A feedhead 52, 54, 56, 58 is associated with each media supply tray 42, 44, 46, 48. Each feedhead 52, 54, 56, 58 selectively removes a single sheet of the media substrate from its associated tray. Persons skilled in the art will recognize that the feedhead can be either integrated with the media tray, or may be formed as part of the printing apparatus to engage a media tray when the media tray is inserted into the printing apparatus. Each feedhead 52, 54, 56, 58 selectively delivers a sheet of the media substrate from its associated media supply tray to a media path 60 that leads to an imaging station 62. At the imaging station the print engine transfers the ink image from the surface of the imaging element 14 to the media substrate.

A media transport 64 moves the media substrates along the media path 60. The media transport may be a series of rollers, or may be other mechanisms, such as a vacuum transport.

A substrate heater 66 along the media path, between the feedheads 52, 54, 56, 58 and the imaging station 62 elevates the temperature of the media substrate. In certain aspects of phase change ink jet printing, image transfer to the substrate is more effective when the substrate is heated prior to image transfer. The substrate heater may be of the type described in U.S. patent application Ser. No. 10/320,821, filed Dec. 16, 2002 by Ihor W. Tarnawskyj, the contents of which are hereby incorporated by reference. A fuser 68 completes the bonding of the ink image to the media substrate. A second, post transfer heater 69 elevates the temperature of the substrate and the ink image thereon for enhanced fusing by the fuser 68.

The printer 10 may include a copying function by including a document exposure scanning system 70. A document feeder 72 further enhances the copying function by delivering a succession of original documents to the document exposure and scanning system 70. The document feeder 72 includes a document holding tray 74 and document sheet feeding and retrieval devices 76. A scanner (not shown) creates an electronic image of documents fed through the scanning system 70.

A controller or electronic subsystem 80 controls the operation of different subsystems, components, and functions of the printer 10. An exemplary controller 80 is a self-contained, dedicated minicomputer having a central processing unit (CPU) 82, electronic storage 84, and a user interface 86 that includes a display. The controller may also include sensor input and control elements 88, as well as pixel placement and control elements 89. The central processing unit 82 reads, captures, prepares and manages the image data flow between an image input source such as the scanning system 70 or an online or work station connection 90, and the print engine.

In operation, image data for an image to be applied to a media substrate is sent to the controller 80 from either the scanning system 70 or the online or work station connection 90. The controller processes the image data and delivers the processed image data to the printheads 32, 34, 36, 38. The controller also determines and/or accepts related subsystem and component controls. For example, the operator can apply input via the user interface 86, and execute such controls. Ink of the appropriate color is melted and delivered to the printheads, and pixel placement control is exercised relative to the surface of the imaging element 14 to form the desired image in accordance with such image data on the surface of the imaging element 14. One of the feedheads 52, 54, 56, 58 delivers the appropriate media substrate from one of the media substrate trays 42, 44, 46, 48 to the media path 60. The media transport 64 transports the media substrates from the feedhead, through the substrate heater 66, to the image transfer station 62, at which the image formed on the surface of the imaging element 14 is transferred to the media substrate. The media transport continues to move the media substrate past the post transfer substrate heater 69 to the fuser 68, and finally to the printer exit 92. Those skilled in the art will recognize that a variety of finishers may be attached at the printer exit, including folders, stackers, staplers, etc.

Attached to the exterior of the printer enclosure 11 may be supporting apparatus, for supporting the enclosure 11 on a surface. An exemplary printer includes wheels or casters 94 for supporting the enclosure 11 on the floor 96. The supporting elements may alternatively include legs and feet, and may include non-skid components. The wheels 94 may include a locking mechanism (not shown) to prevent wheel rotation and printer movement except when desired.

The media supply trays 42, 44, 46, 48 and their associated feedheads 52, 54, 56, 58 are located elevationally above the print engine, and particularly above the image transfer station 62. Such placement of the media supply trays facilitates loading of the media supply trays by placing them at a more convenient elevation relative to a user. For example, in the exemplary floor mounted printing apparatus shown, the upper edges of the media supply trays 42, 44, 46, 48 (and the feedheads 52, 54, 56, 58) may be at an elevation relative to the floor 96 of between 2 feet and 3.5 feet (0.06-1.1 meters). Such placement of the media supply trays positions the media supply tray reloading process nearer to the waist of a typical user.

The positioning of the media supply trays elevationally above the print engine also provides an ample media path prior to image transfer, thereby providing space for the substrate heaters 66 along the media path 60. In addition, positioning the print engine, and particularly the image transfer element in the lower portion of the printer enclosure 11 provides sufficient space for a post transfer media path that is sufficiently lengthy to permit placement of the post transfer substrate heater 69 and the fuser 68, while still permitting the printed media exit 92 to be in the upper portions of the printing apparatus. The upper printed media exit 92 facilitates easy handling of the printed completed substrate by the user. The printed media exit 92 may be at a lower elevation than the media supply trays 42, 44, 46, 48 (and the feedheads 52, 54, 56, 58).

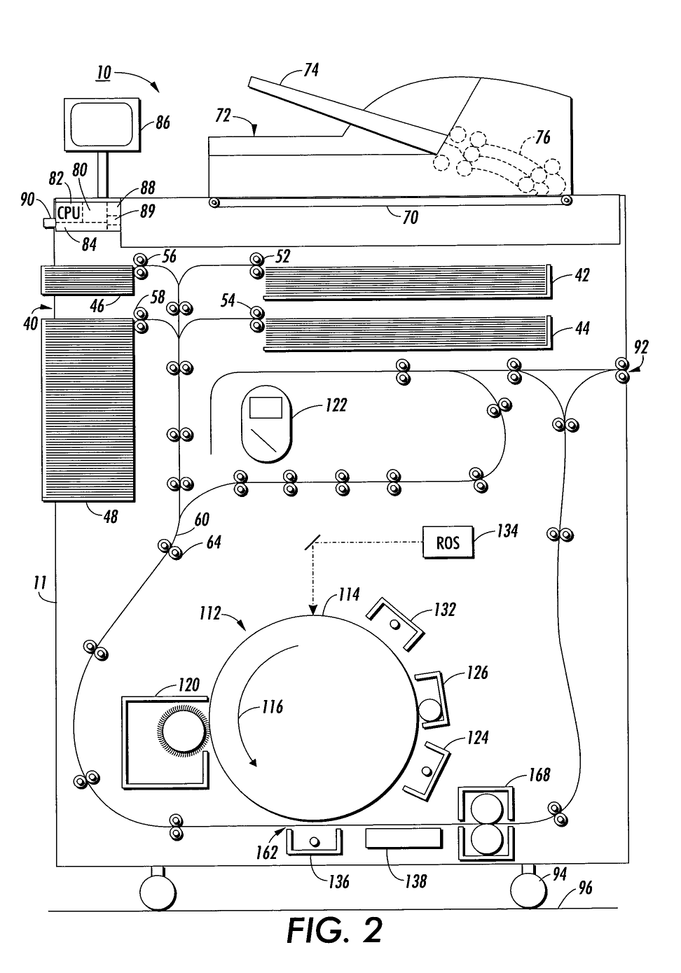

FIG. 2 illustrates a printer having many features similar to the printer illustrated in FIG. 1. However, in lieu of a phase change ink jet printing engine, the printer of FIG. 2 includes a xerographic print engine 112. The xerographic print engine includes an imaging element, such as a photoreceptor belt or drum 114 that moves in a rotational direction 116. A charging corotron 132 uniformly charges the surface of the imaging element. A raster output scanner (ROS) 134 provides an imaging beam that is directed at the photoreceptor 114 to create an electrostatic image on the surface of the photoreceptor consistent with the image data supplied to the printer. The electrostatic image on the surface of the photoreceptor is developed by one or more developers 120. The developers bring toner into proximity with the selectively charged surface of the photoreceptor. A monochrome printer having a single developer is shown. However, persons familiar with the electrostatic printing arts will recognize that a full color printer includes typically four such developers. A toner source 122 supplies toner to the developer 120. A printer with multiple developers 120 may have multiple toner sources 122, with one toner source supplying each developer.

The developed image on the surface is transferred from the surface of the photoreceptor to a media substrate at the image transfer station 162. A transfer corotron 136 enhances the image transfer process. A vacuum transport 138 moves the imaged substrate to a fuser 168, which fuses the image to the media substrate.

A cleaning corotron 124 removes any remaining electrical charge on the surface of the photoreceptor 114. A cleaning device 126 cleans residual toner from the photoreceptor surface.

The media supply trays 42, 44, 46, 48 are located so that the feedheads 52, 54, 56, 58 are elevationally above the xerographic print engine 112, and particularly above the image transfer station 162. The feedheads 52, 54, 56, 58 that selectively deliver media substrates to the media path 60 are in the upper half of the frame or enclosure 11.

Persons familiar with the printer arts will also recognize that the particular print engines shown are exemplary only, and that numerous other configurations can be used. For example, as noted above, in an ink jet embodiment such as is shown in FIG. 1, a different number of printheads may be included. Or, the printheads may be positioned in a different arrangement. In a xerographic embodiment such as the one shown in FIG. 2, a photoreceptive belt may be used in lieu of the photoreceptive drum. A different number of developers may provide additional color capability. Different arrangements of the elements for charging and discharging the photoreceptor surface can also be established.

Persons skilled in the printer arts, upon studying the present disclosure, will also recognize that the principles described can also be applied to a printer using a direct marking technique in which ink images are formed directly on a media substrate by jetting ink directly from an ink jet printhead onto the media substrate.

Various other modifications to the exemplary implementations shown can be made. For example a different number of media supply trays may be included within the printer enclosure, and the exact placement of the media supply trays may be varied. In addition, in certain printing technologies, the print engine can be configured so that the imaging station or image transfer station is on the “top” or upper side of the print engine. Therefore, the engine as defined in the attached claims is not limited to the specific exemplary implementations shown and described above.

1. A printing apparatus comprising:
a print engine comprising an imaging element, an ink jet printhead for applying an ink image to the imaging element, and an image transfer station for transferring the ink image from the imaging element to a media substrate;
at least one media tray for holding a plurality of media substrates in a substantially horizontal orientation;
a feedhead for selectively removing one of the media substrates from the media tray;
a substrate heater; and
a media transport for transporting the media substrate from the feedhead, past the substrate heater, and to the image transfer station;
wherein the image transfer station is at a lower elevation than the feedhead.

2. (Cancelled)

3. The printing apparatus of claim 1, additionally comprising:
a second media tray for holding a second plurality of media substrates in a substantially horizontal orientation; and
a second feedhead for selectively removing one media substrate from the second media tray;
wherein the image transfer station is at a lower elevation than both the first and second feedheads.

4. The printing apparatus of claim 3, wherein the media transport transports media substrate from the second feedhead, past the substrate heater, and to the image transfer station.

5. The printing apparatus of claim 4, additionally comprising a printed media exit for exiting imaged media substrates, wherein the printed media exit is at a lower elevation than both the first and second feedheads.

6. A printing apparatus comprising;
a print engine comprising an imaging element, an ink let printhead for applying an ink image to the imaging element, and an image transfer station for transferring the ink image from the imaging element to a media substrate;
a first media tray for holding a plurality of media substrates;
a first feedhead for selectively removing one of the media substrates from the first media tray;
a second media tray for holding a second plurality of media substrates;
a second feedhead for selectively removing one media substrate from the second media tray;
a substrate heater;
a media transport for transporting the media substrate from the feedhead, past the substrate heater, and to the image transfer station; and
a printed media exit for exiting imaged media substrates;
wherein the media transport transports media substrate from the second feedhead, past the substrate heater, and to the image transfer station;
wherein the image transfer station is at a lower elevation than both the first and second feedheads;
wherein the printed media exit is at a lower elevation than both the first and second feedheads and
wherein the printed media exit is at a higher elevation than the image transfer station.

7. A printing apparatus comprising:
a print engine having an imaging station, for applying an image to a media substrate at the imaging station;
a first media tray for holding a plurality of media substrates;
a first feedhead for selectively removing one of the media substrates from the first media tray;
a second media tray for holding a plurality of media substrates;
a second feedhead for selectively removing one of the media substrates from the second media tray;
a third media tray for holding a plurality of media substrates;
a third feedhead for selectively removing one of the media substrates from the third media tray; and
a media transport for moving the media substrate from the first, second, and third feedheads to the imaging station;
wherein the imaging station is at a lower elevation than all of the first, second, and third feedheads.

8. The printing apparatus of claim 7, additionally comprising a printed media exit for exiting imaged media substrates, wherein the printed media exit is at a lower elevation than both the first and second feedheads.

9. A printing apparatus comprising:
a print engine having an imaging station, for applying an image to a media substrate at the imaging station;
a first media tray for holding a plurality of media substrates;
a first feedhead for selectively removing one of the media substrates from the first media tray;
a second media tray for holding a plurality of media substrates;
a second feedhead for selectively removing one of the media substrates from the second media tray; and
a media transport for moving the media substrate from the first and second feedheads to the imaging station;
wherein the imaging station is at a lower elevation than all of the first and second feedheads; and
a printed media exit for exiting imaged media substrates, wherein the printed media exit is at a lower elevation than both the first and second feedheads;
wherein the printed media exit is at a higher elevation than the imaging station.

10-12. (Cancelled)

13. The printing apparatus of claim 8, wherein:
the imaging element is a photoreceptor;
the print engine additionally comprises a charging system for forming an electrostatic image on the photoreceptor, and a developer for developing the electrostatic image on the photoreceptor.

14. A printing apparatus comprising:
a print engine having an imaging station, for applying an image to a media substrate at the imaging station;
a plurality of media trays, each of for holding a plurality of media substrates;
a plurality of feedheads, each for selectively removing one of the media substrates from an associated one of the media trays; and
a media path between the feedheads and the imaging station;
wherein the imaging station is at a lower elevation than all of the feedheads; and
wherein the imaging station is vertically aligned with at least one of the media trays.

15. The printing apparatus of claim 14, wherein the print engine comprises an ink jet printhead, and the printing apparatus additionally comprises a substrate heater along the media path between the feedheads and the imaging station.

16. (Cancelled)

17. The printing apparatus of claim 14, wherein:
the print engine comprises a xerographic print engine having a photoreceptor; and
the imaging station comprises a transfer station at which an image is transferred from the photoreceptor to the media substrate.

18. The printing apparatus of claim 14, additionally comprising a printed media exit for exiting imaged media substrates, wherein the plurality of feedheads includes first and second feedheads, and wherein the printed media exit is at a lower elevation than both the first and second feedheads.

19. A printing apparatus comprising:
a print engine having an imaging station, for applying an image to a media substrate at the imaging station;
a plurality of media trays, each of for holding a plurality of media substrates;
a plurality of feedheads, each for selectively removing one of the media substrates from an associated one of the media trays;
a media path between the feedheads and the imaging station;
wherein the imaging station is at a lower elevation than all of the feedheads;
wherein the print engine comprises an ink jet printhead, and
the printing apparatus additionally comprises a substrate heater along the media path between the feedheads and the imaging station;
wherein the printed media exit is at a higher elevation than the imaging station.

20. The printing apparatus of claim 3, wherein the image transfer station is vertically aligned with at least one of the media trays.

21. The printing apparatus of claim 3, additionally comprising:
a third media tray for holding a third plurality of media substrates in a substantially horizontal orientation; and
a third feedhead for selectively removing one media substrate from the third media tray;
wherein the image transfer station is additionally at a lower elevation than third feedhead.

22. The printing apparatus of claim 7, wherein the imaging station is vertically aligned with at least one of the media trays.

23. The printing apparatus of claim 7, wherein at least one of the first, second, or third media trays contains print media in a substantially horizontal orientation.

24. The printing apparatus of claim 14, wherein each of the plurality of media trays hold the media substrates in a substantially horizontal orientation.

25. The printing apparatus of claim 14, wherein:
the plurality of media trays includes at least first, second, and third media trays;
the plurality of feedheads includes at least first, second, and third feedheads; and
the imaging station is at a lower elevation than all of the first, second, and third feedheads.
